(19) United States
(12) Patent Application Publication
(10) Pub. No.: US 2006/0160605 A1
(43) Pub. Date: Jul. 20, 2006

(54) Wagering game with enhanced payline-ordering feature

(75) Inventors: Jeremy M. Hornik, Chicago, IL (US); Dion K. Aoki, Henderson, NV (US); Joel R. Jaffe, Glenview, IL (US); James J. Poole, Chalfont St. Giles (GB); Allon G. Englman, Chicago, IL (US)

Correspondence Address: Daniel J. Burnham;Jenkens & Gilchrist, a Professional Corporation, Suite 2600, 225 West Washington Street, Chicago, IL, 60606-3418, US

(73) Assignee: WMS Gaming Inc.

(21) Appl. No.: 11/331,648

(22) Filed: Jan. 13, 2006

Related U.S. Application Data
(60) Provisional application No. 60/645,541, filed on Jan. 18, 2005.

(51) Int. Cl. A63F 13/00

(52) U.S. Cl. 463/20

(57) ABSTRACT

The present invention is directed to a gaming terminal and a method of playing a wagering game. The wagering game includes a plurality of symbols arranged along one or more paylines that indicate a randomly selected outcome of the wagering game in response to a wager input. A winning combination of symbols along the paylines may be arranged in either a left-to-right order or a right-to-left order. In one embodiment, a player makes a first wager input that is associated with one or more paylines corresponding to a left-to-right arrangement of symbols. A player is then allowed to make a second wager input that is associated with one or more paylines corresponding to a right-to-left arrangement of symbols. The second wager input associated with right-to-left paylines is not equal to, and may be less than, the first wager input associated with left-to-right paylines.

### CROSS REFERENCE TO RELATED APPLICATION

This application claims the benefit of priority of U.S. Provisional Patent Application No. 60/645,541, filed Jan. 18, 2005, which is hereby incorporated by reference in its entirety.

### FIELD OF THE INVENTION

The present invention relates generally to gaming terminals and methods of playing wagering games at the gaming terminals, and more particularly, to gaming terminals and methods of playing wagering games having a unique payline-ordering feature.

### BACKGROUND OF THE INVENTION

Gaming machines, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines.

Consequently, shrewd operators strive to employ the most entertaining and exciting machines available because such machines attract frequent play and, hence, increase profitability to the operator. In the competitive gaming machine industry, there is a continuing need for gaming machine manufacturers to produce new types of games, or enhancements to existing games, which will attract frequent play by enhancing the entertainment value and excitement associated with the game.

One concept that has been successfully employed to enhance the entertainment value of a game is that of a “bonus” game which may be played in conjunction with a “basic” game. The bonus game may comprise any type of game, either similar to or completely different from the basic game, and is entered upon the occurrence of a selected event or outcome of the basic game. Such a bonus game produces a significantly higher level of player excitement than the basic game because it provides a greater expectation of winning than the basic game.

Another concept that has been employed is the use of a progressive jackpot. In the gaming industry, a “progressive” involves collecting coin-in data from participating gaming device(s) (e.g., slot machines), contributing a percentage of that coin-in data to a jackpot amount, and awarding that jackpot amount to a player upon the occurrence of a certain jackpot-won event. The percentage of the coin-in is determined prior to any result being achieved and is independent of any result. A jackpot-won event typically occurs when a “progressive winning position” is achieved at a participating gaming device. If the gaming device is a slot machine, a progressive winning position may, for example, correspond to alignment of progressive jackpot reel symbols along a certain payline. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement.

In addition to the features described above, there is a continuing need for gaming machine manufacturers to continuously develop new games and improved gaming enhancements that will attract frequent game play through enhanced entertainment value to the player. For example, one feature common to many wagering games are single or multiple paylines that provide awards to players based on an arrangement of symbols along one or more of the paylines. According to some wagering games, a winning combination of symbols along one or more of the paylines can occur as the symbols are read from left-to-right and/or right-to-left. Thus, in these types of wagering games, players may have more than one way of achieving a winning combination along any given set of paylines.

For wagering games that offer left-to-right and right-to-left ordering of symbols along a single or multiple paylines, players are usually required to bet an equal wager amount for each payline, i.e., a player must bet 10 credits for a left-to-right payline(s) and 10 credits for a right-to-left payline(s). Alternatively, players may place a single wager that covers both left-to-right and right-to-left paylines.

To offer players more variety and control over their wager inputs, shrewd operators of wagering games allow players to wager varying amounts on different paylines. In particular, a wagering game that allows players to wager a different amount on one payline or group of paylines than on another payline or group of paylines offers players more variety in their wagering options and encourages players to bet more money on the wagering game.

Thus, by allowing players to wager a first amount on a left-to-right payline or group of paylines and a second amount on a right-to-left payline or group of paylines where the second amount wagered is not equal to the first amount wagered, the present invention offers new and different ways of wagering and winning at gaming terminals. This increases the level of excitement and anticipation associated with playing wagering games, and consequently, attracts new players and keeps current players at the gaming terminals.

### SUMMARY OF THE INVENTION

In one aspect of the present invention, a gaming terminal for playing a wagering game includes a basic game having a plurality of reels composed of a plurality of symbols that indicate a randomly selected outcome of the basic game that has been selected from a plurality of outcomes in response to receiving a first wager input. The first wager input is associated with a first group of paylines that indicate the randomly selected outcome from left-to-right. An option for inputting a second wager input is also included at the gaming terminal. The second wager input is associated with a second group of paylines that indicate the randomly selected outcome from right-to-left. The second wager input that is associated with the second group of paylines is not equal to the first wager input that is associated with the first group of paylines.

In another aspect of the present invention, a method of playing a wagering game at a gaming terminal is disclosed. The wagering game has a plurality of reels composed of a plurality of symbols that indicate a randomly selected outcome of the wagering game that has been selected from a plurality of outcomes. The method includes receiving a first wager input that is associated with a first group of paylines that indicates the randomly selected outcome from left-to-right; providing an option for inputting a second wager input that is associated with a second group of paylines that indicate the randomly selected outcome from right-to-left in which the second wager input is not equal to said first wager input; conducting the wagering game; awarding an award for at least one winning combination of the plurality of symbols along the first group of paylines that indicate the randomly selected outcome from left-to-right; and, if the player-selectable option has been chosen, awarding an award for at least one winning combination of the plurality of symbols along the second group of paylines that indicate the randomly selected outcome from right-to-left.

In another aspect of the present invention, a gaming terminal for playing a wagering game includes a display for displaying a plurality of symbols that indicate a randomly selected outcome of the wagering game. The display displays at least one payline. A controller is coupled to the display and operates to receive a first wager input and a second wager input. The first wager input allows a player to achieve winning combinations arranged left-to-right on the payline and the second wager input allows a player to achieve winning combinations arranged right-to-left along on the payline. The second wager input is less than the first wager input.

In yet another aspect of the present invention, a method for conducting a wagering game includes providing the wagering game at a gaming terminal that is capable of receiving a first wager input and a second wager input. The first wager input and the second wager input are received wherein the second wager input is less than the first wager input. A combination of symbols is displayed that is capable of being read from left-to-right and right-to-left along at least one payline. The first wager input is associated with symbols read from left-to-right and the second wager input is associated with symbols read from right-to-left.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 is a perspective view of a gaming terminal according to one embodiment of the present invention.

FIG. 2 is a block diagram of the gaming terminal of FIG. 1.

FIG. 3 illustrates a gaming terminal displaying a left-to-right winning combination according to one embodiment of the present invention.

FIG. 4 illustrates a gaming terminal displaying a right-to-left winning combination according to one embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

The present invention is directed to a gaming terminal and a method of playing a wagering game. The wagering game includes a plurality of symbols arranged along one or more paylines that indicate a randomly selected outcome of the wagering game in response to a wager input. A winning combination of symbols along the paylines may be arranged in either a left-to-right order or a right-to-left order. In one embodiment, a player makes a first wager input that is associated with one or more paylines corresponding to a left-to-right arrangement of symbols. A player is then allowed to make a second wager input that is associated with one or more paylines corresponding to a right-to-left arrangement of symbols. The second wager input associated with right-to-left paylines is not equal to the first wager input associated with left-to-right paylines. In some embodiments, the second wager input is less than the first wager input. In other embodiments, the second wager input is greater than the first wager input.

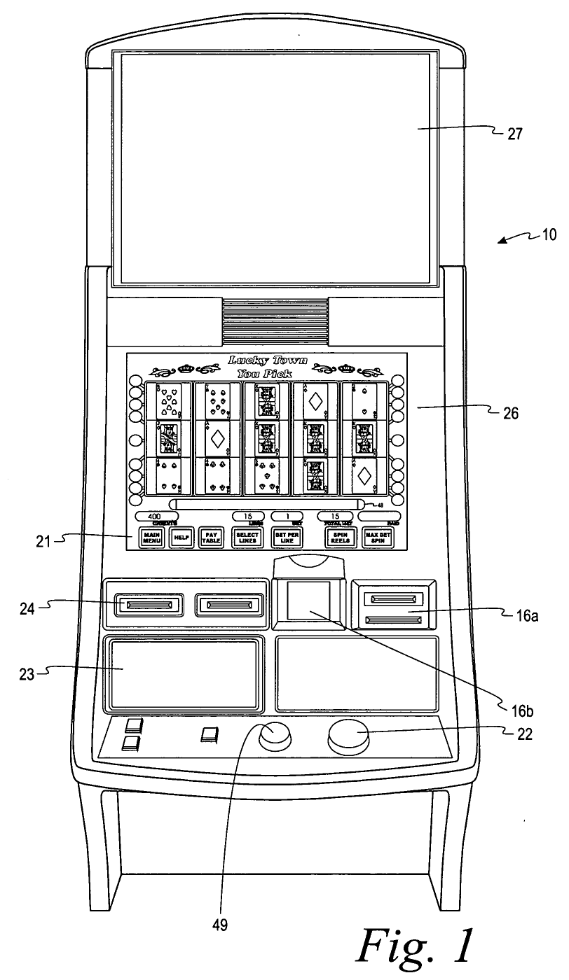

FIG. 1 shows a perspective view of a typical gaming terminal 10 used by gaming establishments, such as casinos. With regard to the present invention, the gaming terminal 10 may be any type of gaming terminal and may have varying structures and methods of operation. For example, the gaming terminal 10 may be a mechanical gaming terminal configured to play mechanical slots, or it may be an electromechanical or electrical gaming terminal configured to play video slots.

As shown, the gaming terminal 10 includes input devices, such as a wager acceptor 16 (shown as a card wager acceptor 16a and a cash wager accepter 16b), a touch screen 21, a push-button panel 22, and an information reader 24. For outputs, the gaming terminal 10 includes a payout mechanism 23, a main display 26 for displaying information about the basic wagering game, and a secondary display 27 that may display an electronic version of a pay table, information about a bonus game, and/or also possibly game-related information or other entertainment features. While these typical components found in the gaming terminal 10 are described below, it should be understood that numerous other elements may exist and may be used in any number of combinations to create various forms of a gaming terminal.

The wager acceptor 16 may be provided in many forms, individually or in combination. The cash wager acceptor 16b may include a coin slot acceptor or a note acceptor to input value to the gaming terminal 10. The card wager acceptor 16a may include a card-reading device for reading a card that has a recorded monetary value with which it is associated. The card wager acceptor 16a may also receive a card that authorizes access to a central account, which can transfer money to the gaming terminal 10.

Also included is the payout mechanism 23, which performs the reverse functions of the wager acceptor. For example, the payout mechanism 23 may include a coin dispenser or a note dispenser to output value from gaming terminal 10. Also, the payout mechanism 23 may also be adapted to receive a card that authorizes the gaming terminal to transfer credits from the gaming terminal 10 to a central account.

The push button panel 22 is typically offered, in addition to the touch screen 21, to provide players with an option on how to make their game selections. Alternatively, the push button panel 22 provides inputs for one aspect of operating the game, while the touch screen 21 allows for inputs needed for another aspect of operating the game.

The operation of the basic wagering game is displayed to the player on the main display 26. The main display 26 may take the form of a cathode ray tube (CRT), a high resolution LCD, a plasma display, LED, or any other type of video display suitable for use in the gaming terminal 10. As shown, the main display 26 includes the touch screen 21 overlaying the entire display (or a portion thereof) to allow players to make game-related selections. Alternatively, the main display 26 of the gaming terminal 10 may include a number of mechanical reels to display the game outcome in visual association with at least one payline. The secondary display 27 may display information relating to the basic wagering game or a bonus game. Like the main display 26, the secondary display 27 may take the form of a cathode ray tube (CRT), a high resolution LCD, a plasma display, LED, or any other type of video display suitable for use in the gaming terminal 10.

In some embodiments, the information reader 24 is a card reader that allows for identification of a player by reading a card with information indicating his or her true identity. Currently, identification is used by casinos for rewarding certain players with complimentary services or special offers. For example, a player may be enrolled in the gaming establishment's players' club and may be awarded certain complimentary services as that player collects points in his or her player-tracking account. The player inserts his or her card into the player-identification card reader 24, which allows the casino's computers to register that player's wagering at the gaming terminal 10. The information reader 24 may also include a keypad (not shown) for entering a personal identification number (PIN). The gaming terminal 10 may require that the player enter their PIN prior to obtaining information. The gaming terminal 10 may use the secondary display 27 for providing the player with information about his or her account or other player-specific information. Also, in some embodiments, the information reader 24 may be used to restore assets that the player achieved during a previous game session and had saved.

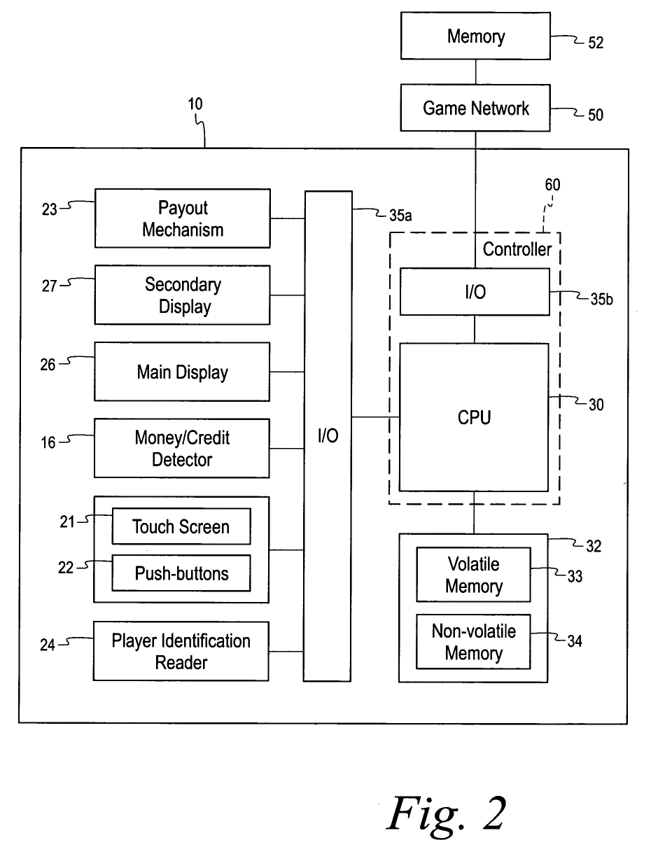

As shown in FIG. 2, the various components of the gaming terminal 10 are controlled by a central processing unit (CPU) 30 (such as a microprocessor or microcontroller). To provide the gaming functions, the CPU 30 executes a game program that allows for the randomly selected outcome. The CPU 30 is also coupled to or includes a local memory 32. The local memory 32 may comprise a volatile memory 33 (e.g., a random-access memory (RAM)) and a non-volatile memory 34 (e.g., an EEPROM). It should be appreciated that the CPU 30 may include one or more microprocessors. Similarly, the local memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral components of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

In some embodiments, the CPU 30 may not be inside the gaming terminal 10. Instead, the CPU 30 may be part of a game network 50 (FIG. 2) and may be used to control numerous gaming terminals 10. In these embodiments, the CPU 30 will run the basic games for each of the gaming terminals 10, and may also be used to link the gaming terminals 10 together. The game network 50 can include progressive jackpots that are contributed to by all or some of the gaming terminals 10 in the network (e.g., terminal-level jackpots that only each terminal 10 contributes to, bank-level jackpots that are contributed to by all of the terminals 10 in a particular bank, and wide-area jackpots that are contributed to by a larger number of terminals 10, such as multiple banks).

The gaming terminal 10 and associated gaming control system is capable of executing wagering games on or through a controller 60. Controller 60, as used herein, comprises any combination of hardware, software, and/or firmware that may be disposed or resident inside and/or outside of a gaming terminal 10 or like machine which may communicate with and/or control the transfer of data between the gaming terminal and a bus, another computer, processor, or device, and/or a service and/or a network. The network may include, but is not limited to a peer-to-peer, client/server, master/slave, star network, ring network, bus network, or other network architecture wherein at least one processing device (e.g., computer) is linked to at least one other processing device. The controller 60 may comprise the I/O circuits 35a and 35b and the CPU 30. In other embodiments, the CPU 30 may be housed outside of the controller 60, and a different processor may be housed within the controller 60. The controller 60, as used herein, may comprise one or more controllers. In one implementation, each gaming terminal 10 comprises, or is connected to, a controller 60 enabling each gaming terminal 10 to transmit and/or receive signals, preferably both, in a peer-to-peer arrangement. In another example, the controller 60 may be adapted to facilitate communication and/or data transfer for one or more gaming terminals 10 in a client/server or centralized arrangement. In one aspect, shown in FIG. 2, the controller 60 may connect the gaming terminal 10 via a conventional I/O port and communication path (e.g. serial, parallel, IR, RC, 10bT, etc.) to a game network 50, which may include, for example, other gaming terminals connected together in the network 50.

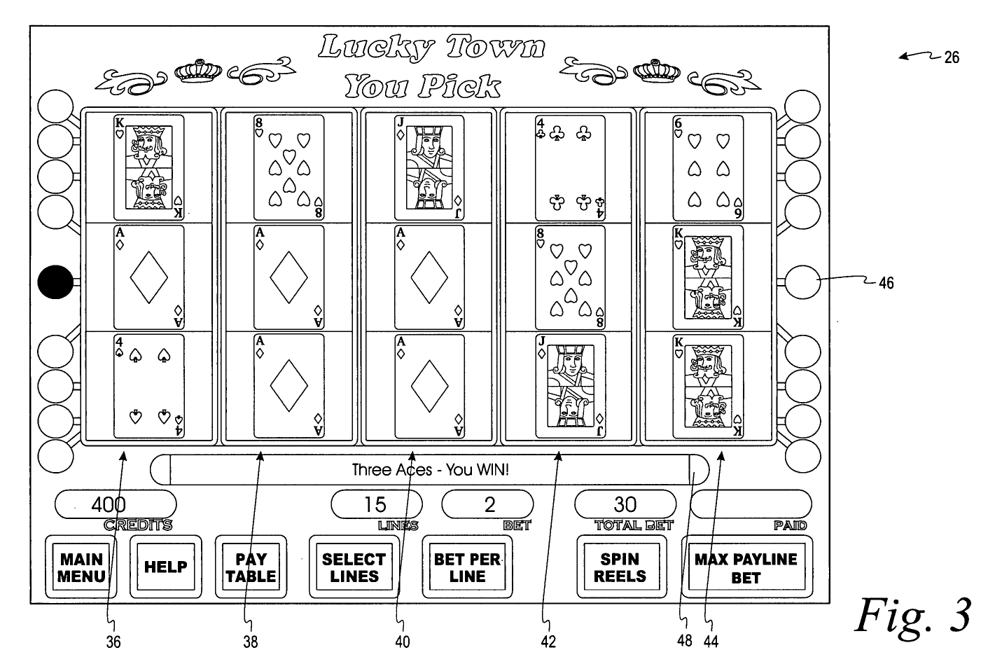

The main display 26 of one embodiment of the present invention is shown in more detail in FIG. 3. In this embodiment, the basic wagering game is a slot machine game, with symbols on five different reels 36, 38, 40, 42, 44. The reels 36-44 may be either traditional mechanical reels or they may be computer-generated images of reels, with each reel composed of a plurality of symbols. Upon receiving a wager input, the payline indicators 46 indicate which paylines have been selected (i.e., activated) by the player. A randomly selected outcome from a plurality of outcomes is then indicated along the active paylines in the form of a combination of symbols on the reels 36-44. Also, an outcome indicator 48 indicates whether the outcome has resulted in a winning outcome or a non-winning outcome. While multiple paylines are shown, a gaming terminal 10 with a single payline will also work with the present invention.

According to one embodiment, some of the paylines of the present invention indicate an outcome that corresponds to a combination of symbols that are arranged from left-to-right. That is, the combination of symbols is determined by the order of the symbols starting from reel 36 and moving in a consecutive manner to reel 38, reel 40, reel 42 and ending with reel 44. Alternatively, some paylines indicate an outcome that corresponds to a combination of symbols that are arranged from right-to-left. That is, the combination of symbols is determined by the order of the symbols starting from reel 44 and moving in a consecutive manner to reel 42, reel 40, reel 38 and ending with reel 36.

In one embodiment of the present invention, a player makes a first wager input (e.g., via the card wager acceptor 16a or the cash wager acceptor 16b in FIGS. 1-2) that is associated with a first group of paylines that are selected by a player. The first group of paylines is associated with a plurality of symbols that indicate a randomly selected outcome that is arranged from left-to-right. If certain conditions are met, a player may be allowed to make a second wager input via a player-selectable option. The second wager input is associated with a second group of paylines that are selected by the player. The second group of paylines is associated with a plurality of symbols that indicate a randomly selected outcome that is arranged from right-to-left. This option of wagering on paylines may be made available to a player via a button on the push-button panel 22 or via the touch-screen 21. Alternatively, the left-to-right paylines and the right-to-left paylines may be activated automatically, such as when a player makes a wager input at the gaming terminal.

In some embodiments, the player-selectable option for inputting a second wager input may only be selected after a player has input a first wager input that is equal to a maximum wager input (i.e., a “max payline bet”). If the first wager input is not equal to the maximum wager input at a gaming terminal, then the player-selectable option will not be selectable. For example, the player-selectable button 49 (FIG. 1), which is part of the push-button panel 22, will not be illuminated or the player-selectable option on the touch screen 21 will not be highlighted.

Once a maximum wager input is received for the first wager input, the player may select to enter a second wager input. In one embodiment of the present invention, the second wager input is less than the first wager input. For example, in a wagering game having fifteen (15) left-to-right paylines and fifteen (15) right-to-left paylines, the first wager input associated with one or more left-to-right paylines may be two credits and the second wager input associated with one or more right-to-left paylines may be one credit. In an alternative embodiment, a player is allowed to make a second wager input that is greater than the first wager input. This allows a player to wager a greater amount on the right-to-left paylines which may provide a greater award than winning combinations along left-to-right paylines. These options offer more flexibility in wagering and more player excitement than traditional wagering games.

In one embodiment, in order to purchase the discounted right-to-left paylines, the player must purchase all of the left-to-right paylines (the “max payline bet”). The player could then purchase all of the right-to-left paylines or as many of the right-to-left paylines as the player wants. This betting scheme motivates player to place additional wagers because the cost of wagering on paylines associated with right-to-left ordering of symbols is lower.

The paylines associated with the left-to-right ordering of symbols may be the same as the paylines associated with the right-to-left ordering of symbols, i.e., one payline is capable of having left-to-right and right-to-left combinations. Alternatively, some paylines may be associated exclusively with left-to-right ordering of symbols while other paylines may be associated exclusively with right-to-left ordering of symbols. Furthermore, the left-to-right or right-to-left paylines may vary from one wagering game to another, as well as from one round of a wagering game to another round, i.e., one round may have paylines A through F designated as left-to-right paylines and paylines G through L designated as right-to-left paylines while another round or game may have paylines A through C and G through I designated as left-to-right paylines and paylines D through I and J through L designated as right-to-left paylines.

The number of left-to-right paylines may also be different from the number of right-to-left paylines, such that the number of paylines in the first group of paylines is greater than the number of paylines in the second group of paylines. Alternatively, the number of paylines in the first group of paylines may be less than the number of paylines in the second group of paylines. Additionally, a group of paylines may contain one or more paylines.

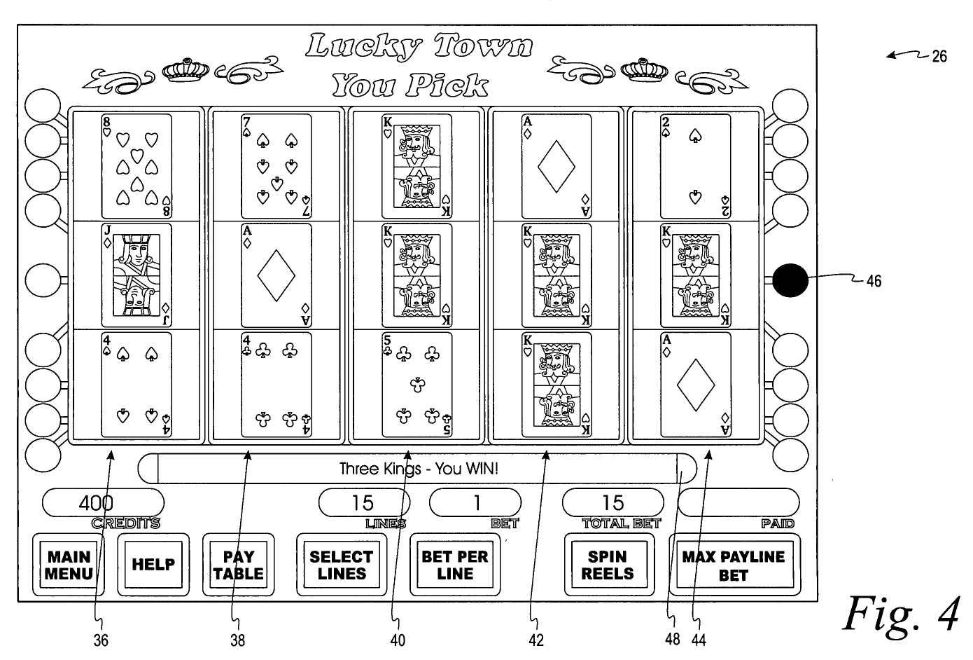

In one embodiment, a winning combination of symbols may include at least three symbols arranged in consecutive order starting from the furthermost left reel, i.e., reel 36 for a left-to-right payline, or starting from the furthermost right reel, i.e., reel 44 for a right-to-left payline. FIG. 3 shows a main display 26 that displays a winning combination for a left-to-right payline. Specifically, the main display 26 in FIG. 3 displays the symbols “Ace Ace Ace Eight King” along the center payline. Three consecutive “Aces” along the left-to-right payline indicate a winning combination. By comparison, FIG. 4 shows a main display 26 that displays a winning combination for a right-to-left payline. The display in FIG. 4 displays the symbols “Jack Ace King King King.” In this case, three consecutive “Kings” along the right-to-left payline indicate a winning combination. It should be noted that the three consecutive “Kings” in FIG. 4 would not result in a winning combination on the left-to-right format because the first reel 36 lacks a “King” that is part of the winning combination. Hence, the right-to-left arrangement may result in winning combinations that are not otherwise available in a left-to-right arrangement.

Other winning combinations are possible in the wagering game of the present invention. For example, a winning combination may include consecutive matching symbols along one payline on each of the five reels 36-44. When five matching symbols occur along one payline, both the left-to-right and right-to-left order of symbols are winning combinations. In this situation, where the symbols constitute a winning combination in each direction, a player may receive an award for each winning combination i.e., a player receives an award for the winning left-to-right payline and an award for the winning right-to-left payline. Alternatively, a player may receive an award for the winning left-to-right payline and access to a new bonus game for the winning right-to-left payline. Thus, by placing an additional wager input on the right-to-left payline, that may be lower than the original wager on the left-to-right payline, a player is rewarded with a double award for a single combination of symbols. In other embodiments, the player may be rewarded only one award.

The above examples are not meant to limit the possible winning combinations that are available in the wagering game. Additionally, the present invention can include other wagering games having different types of symbols.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method of playing a wagering game at a gaming terminal, said wagering game having a plurality of reels composed of a plurality of symbols that indicate a randomly selected outcome of said wagering game that has been selected from a plurality of outcomes, comprising:
receiving a first wager input that is associated with a first group of paylines that indicate said randomly selected outcome from left-to-right;
providing an option for inputting a second wager input, said second wager input associated with a second group of paylines that indicate said randomly selected outcome from right-to-left, said second wager input is not equal to said first wager input;
conducting said wagering game;
awarding an award for at least one winning combination of said plurality of symbols along said first group of paylines that indicate said randomly selected outcome from left-to-right; and
awarding an award for at least one winning combination of said plurality of symbols along said second group of paylines that indicate said randomly selected outcome from right-to-left if said option has been chosen.

2. The method of claim 1, wherein said first group of paylines is the same as said second group of paylines.

3. The method of claim 1, wherein said second wager input associated with said second group of paylines is less than said first wager input associated with said first group of paylines.

4. The method of claim 1, wherein said second wager input associated with said second group of paylines is greater than said first wager input associated with said first group of paylines.

5. The method of claim 1, wherein the number of paylines in said first group of paylines is greater than the number of paylines in said second group of paylines.

6. The method of claim 1, wherein the number of paylines in said first group of paylines is less than the number of paylines in said second group of paylines.

7. The method of claim 1, wherein said option for inputting said second wager input is only selectable in response to a player inputting said first wager input that is equal to a maximum value for a payline within said first group of paylines.

8. The method of claim 7, wherein said option is only selectable in response to said player selecting all of said paylines within said first group of paylines and said first wager input is equal to a maximum value for all paylines in said first group of paylines.

9. A gaming terminal for playing a wagering game, comprising:
a display for displaying a plurality of symbols that indicate a randomly selected outcome of said wagering game, said display displaying at least one payline;
a controller coupled to said display and operative to receive a first wager input and a second wager input, said first wager input allowing a player to achieve winning combinations arranged left-to-right on said payline and said second wager input allowing a player to achieve winning combinations arranged right-to-left on said payline; and
wherein said second wager input is less than said first wager input.

10. The gaming terminal of claim 9, further comprising a player-selectable input device coupled to said controller for inputting said second wager input.

11. The gaming terminal of claim 10, wherein said player-selectable input device for inputting said second wager input is only actuatable in response to a player inputting said first wager input that is equal to a maximum value for said payline.

12. The gaming terminal of claim 9, wherein said winning combinations arranged right-to-left or left-to-right on said payline include at least three symbols arranged in consecutive order.

13. The gaming terminal of claim 9, wherein one of said winning combinations includes symbols arranged in consecutive order on each reel along said payline such that said left-to-right arrangement and said right-to-left arrangement are winning combinations.

14. The gaming terminal of claim 13, wherein a player is awarded a first award based on said left-to-right arrangement of symbols and a second award based on said right-to-left arrangement of symbols.

15. The gaming terminal of claim 13, wherein a player is awarded a first award based on said left-to-right arrangement of symbols and a chance for a bonus award based on said right-to-left arrangement of symbols.

16. A method for conducting a wagering game, comprising:
providing said wagering game at a gaming terminal, said wagering game capable of receiving a first wager input and a second wager input;
receiving said first wager input and said second wager input wherein said second wager input is less than said first wager input;
displaying a combination of symbols, said combination of symbols capable of being read from left-to-right and right-to-left along at least one payline; and
wherein said first wager input is associated with symbols read from left-to-right and said second wager input is associated with symbols read from right-to-left.

17. The method of claim 16, wherein said second wager input can only be received if said first wager input is equal to a maximum value.

18. The method of claim 16, further comprising awarding a first award based on said symbols being read from left-to-right.

19. The method of claim 16, further comprising awarding a second award based on said symbols being read from right-to-left.

20. The method of claim 16, further comprising awarding a first award based on said symbols being read from left-to-right and awarding a second award based on said symbols being read from right-to-left, said second award being a chance to win a bonus award.
